(19) United States
(12) Patent Application Publication
(10) Pub. No.: US 2013/0241508 A1
(43) Pub. Date: Sep. 19, 2013

(54) VOLTAGE REGULATOR

(71) Applicant: SEIKO INSTRUMENTS INC., Chiba-shi (JP)

(72) Inventor: Osamu UEHARA, Chiba-shi (JP)

(73) Assignee: SEIKO INSTRUMENTS INC., Chiba-shi (JP)

(21) Appl. No.: 13/780,708

(22) Filed: Feb. 28, 2013

(30) Foreign Application Priority Data
Mar. 13, 2012 (JP) 2012-055921

(51) Int. Cl. G05F 1/10

(52) U.S. Cl. CPC G05F 1/10
USPC 323/282

(57) ABSTRACT

In a voltage regulator having: a reference voltage generation circuit which generates a reference voltage; an amplifier which amplifies and outputs a difference between the reference voltage and a divided voltage obtained by dividing a voltage output from an output transistor and controls a gate of the output transistor; an external terminal which receives a signal which externally turns on/off a circuit; and a start-up circuit which transmits the reference voltage to the amplifier, the improvement including: a voltage detection circuit which detects the voltage output from the output transistor; and a switch circuit which is connected to the start-up circuit and interrupts a current which flows through the start-up circuit in response to a signal from the voltage detection circuit.

### RELATED APPLICATIONS

This application claims priority under 35 U.S.C. §119 to Japanese Patent Application No. 2012-055921 filed on Mar. 13, 2012, the entire content of which is hereby incorporated by reference.

### BACKGROUND OF THE INVENTION

1. Field of the Invention

The present invention relates to a rush current prevention circuit of a voltage regulator.

2. Description of the Related Art

A conventional voltage regulator will be described below. FIG. 3 is a circuit diagram illustrating the conventional voltage regulator.

The conventional voltage regulator includes a bias circuit 110, an amplifier 111, Nch depression transistors 107 and 112, an NMOS transistor 113, a PMOS transistor 116, a diode 114, resistors 105, 117, and 118, a capacitor 106, inverters 108 and 109, a ground terminal 100, an output terminal 104, a supply terminal 101, a CE terminal 103, and an EN terminal 102.

If a power-supply voltage VDD is applied to the supply terminal 101 and a Hi signal is input to the EN terminal 102, the voltage of the CE terminal 103 starts up slowly due to actions of the resistor 105 and the capacitor 106. The bias circuit 110 to which the signal of the EN terminal 102 is input via the inverters 108 and 109 starts up a little behind the start-up of the voltage and passes a current through the diode 114 and the amplifier 111. Then, a reference voltage VREF is generated at a connection point between the diode 114 and the bias circuit 110 to cause the amplifier 111 to operate. Assuming that a source of the Nch depression transistor 107 is a node N1 and when the CE terminal 103 gradually starts up, the Nch depression transistor 107 is also gradually turned on and the voltage of the node N1 gradually starts up. At this time, the voltage of the node N1 is a value obtained by dividing the power-supply voltage VDD by an ON resistance ratio of the Nch depression transistor 107 and the Nch depression transistor 112 and is lower than the power-supply voltage VDD, and therefore the Nch depression transistor 107 is maintained in the ON state.

The gradual start-up of the voltage of the node N1 causes the NMOS transistor 113 to be gradually turned on and the reference voltage VREF is transmitted to an inverting input terminal of the amplifier 111. In this manner, the voltage of the inverting input terminal of the amplifier 111 slowly rises and the output of the amplifier 111 slowly falls. Then, the PMOS transistor 116 is controlled to be slowly turned on, by which the rush current which flows into the output terminal 104 is suppressed (for example, refer to Patent Document 1). [Patent Document 1] Japanese Patent Application Laid-Open No. 2010-170363

### SUMMARY OF THE INVENTION

The conventional technique, however, has a problem that, after the output voltage starts up, a current continues to flow through the Nch depression transistor 112 and thereby a consumption current increases.

The present invention has been provided in view of the above problem. Therefore, the present invention provides a voltage regulator which prevents the current from passing through the Nch depression transistor 112 after the output voltage starts up to reduce the consumption current of the voltage regulator.

In order to solve the conventional problem, the voltage regulator of the present invention has the following configuration:

In a voltage regulator having: a reference voltage generation circuit which generates a reference voltage; an amplifier which amplifies and outputs a difference between the reference voltage and a divided voltage obtained by dividing a voltage output from an output transistor and controls a gate of the output transistor; an external terminal which receives a signal which externally turns on/off a circuit; and a start-up circuit which transmits the reference voltage to the amplifier, the improvement including: a voltage detection circuit which detects the voltage output from the output transistor; and a switch circuit which is connected to the start-up circuit and interrupts a current which flows through the start-up circuit in response to a signal from the voltage detection circuit.

The voltage regulator including a rush current prevention circuit of the present invention is able to reduce the consumption current of the voltage regulator by stopping the operation of the rush current prevention circuit after the output voltage starts up.

### BRIEF DESCRIPTION OF THE DRAWINGS

FIG. 1 is a circuit diagram illustrating a voltage regulator according to a first embodiment;

FIG. 2 is a circuit diagram illustrating a voltage regulator according to a second embodiment; and

FIG. 3 is a circuit diagram illustrating a conventional voltage regulator.

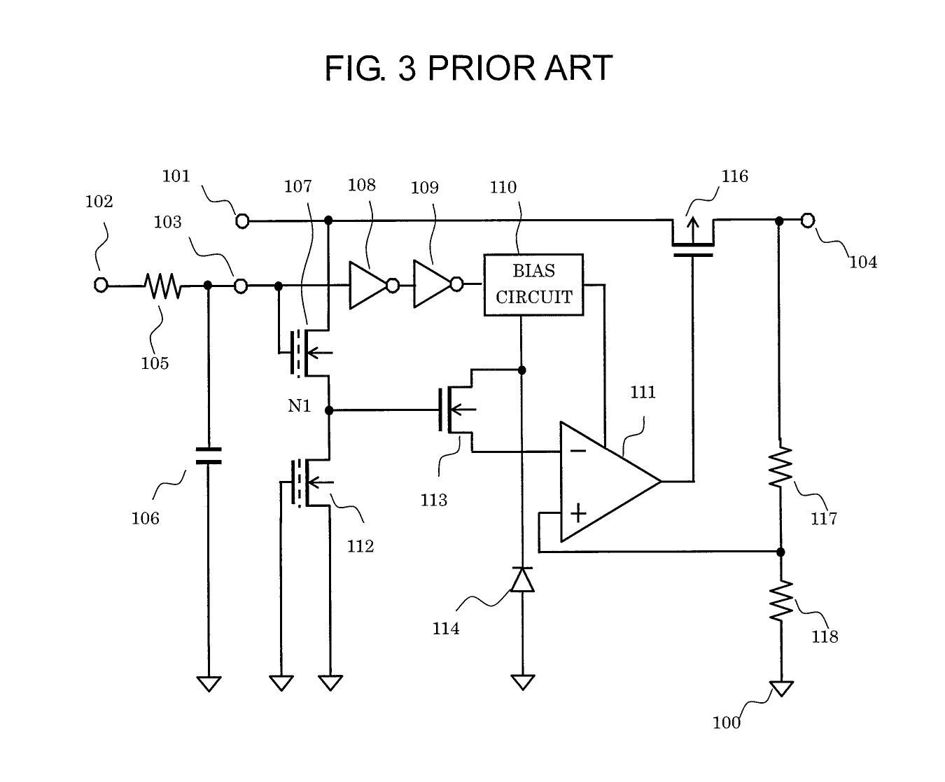

### DETAILED DESCRIPTION OF THE PREFERRED EMBODIMENTS

Hereinafter, preferred embodiments of the present invention will be described with reference to appended drawings.

### First Embodiment

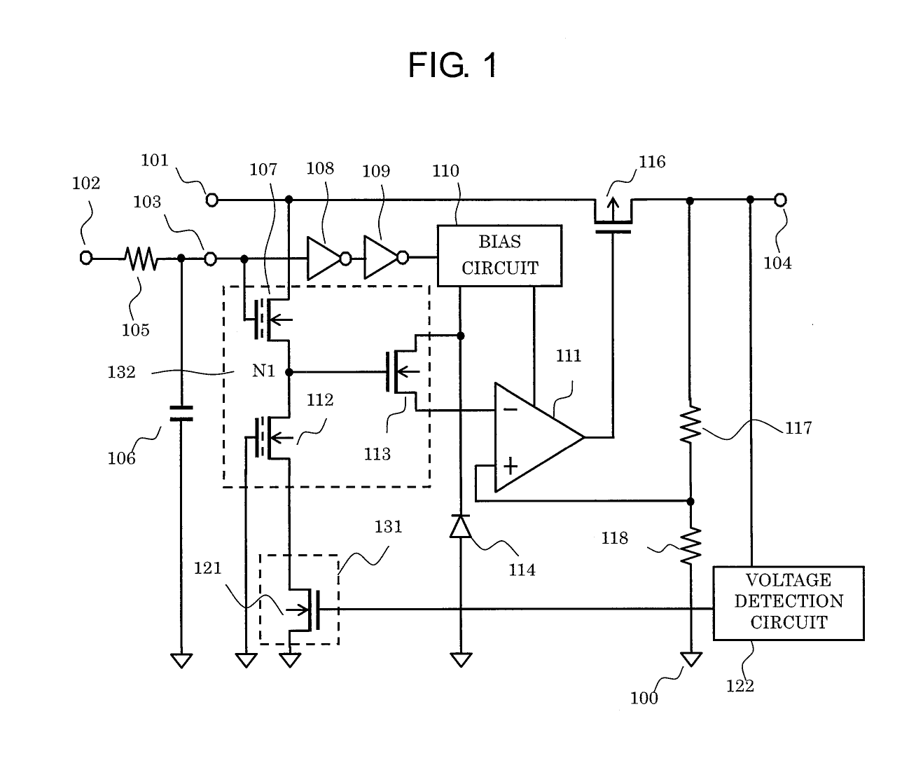

Referring to FIG. 1, there is illustrated a circuit diagram of a voltage regulator according to a first embodiment.

The voltage regulator of the first embodiment includes a bias circuit 110, an amplifier 111, a voltage detection circuit 122, Nch depression transistors 107 and 112, NMOS transistors 113 and 121, a PMOS transistor 116, a diode 114, resistors 105, 117, and 118, a capacitor 106, inverters 108 and 109, a ground terminal 100, an output terminal 104, a supply terminal 101, a CE terminal 103, and an EN terminal 102. A switch circuit 131 includes the NMOS transistor 121. A rush current prevention circuit 132 includes the Nch depression transistors 107 and 112 and the NMOS transistor 113.

Subsequently, the connections of the voltage regulator of the first embodiment will be described. The resistor 105 is connected between the EN terminal 102 and the CE terminal 103. The capacitor 106 is connected between the CE terminal 103 and the ground terminal 100. The Nch depression transistor 107 has a gate connected to the CE terminal 103 and an input of the inverter 108, a drain connected to the supply terminal 101, and a source connected to a drain of the Nch depression transistor 112. The Nch depression transistor 112 has a gate connected to the ground terminal 100 and a source connected to the NMOS transistor 121. The NMOS transistor 121 has a gate connected to an output of the voltage detection circuit 122 and a source connected to the ground terminal 100. The input of the voltage detection circuit 122 is connected to the output terminal 104. The inverter 109 has an input connected to an output of the inverter 108 and an output connected to an input of the bias circuit 110. The bias circuit 110 has a first output connected to a drain of the NMOS transistor 113 and to a cathode of the diode 114 and a second output connected to the amplifier 111. An anode of the diode 114 is connected to the ground terminal 100. The NMOS transistor 113 has a gate connected to the source of the Nch depression transistor 107 and a source connected to an inverting input terminal of the amplifier 111. The amplifier 111 has a non-inverting input terminal connected to a connection point between one terminal of the resistor 117 and one terminal of resistor 118 and an output connected to a gate of the PMOS transistor 116. The PMOS transistor 116 has a drain connected to the output terminal 104 and to the other terminal of the resistor 117 and a source connected to the supply terminal 101. The other terminal of the resistor 118 is connected to the ground terminal 100.

Subsequently, the operation of the voltage regulator of the first embodiment will be described. If a power-supply voltage VDD is applied to the supply terminal 101 and a Hi signal is input to the EN terminal 102, the voltage of the CE terminal 103 starts up slowly due to actions of the resistor 105 and the capacitor 106. The bias circuit 110 starts up a little behind the start-up of the voltage via the inverters 108 and 109 and passes a current through the diode 114 and the amplifier 111. Then, a reference voltage VREF is generated at a connection point between the diode 114 and the bias circuit 110 to cause the amplifier 111 to operate.

Assuming that the source of the Nch depression transistor 107 is a node N1 and when the CE terminal 103 gradually starts up, the Nch depression transistor 107 is also gradually turned on and the voltage of the node N1 gradually starts up. At this time, the voltage of the node N1 is a value obtained by dividing the power-supply voltage VDD by an ON resistance ratio of the Nch depression transistor 107 and the Nch depression transistor 112 and is lower than the power-supply voltage VDD, and therefore the Nch depression transistor 107 is maintained in the ON state.

The gradual start-up of the voltage of the node N1 causes the NMOS transistor 113 to be gradually turned on and the reference voltage VREF is transmitted to an inverting input terminal of the amplifier 111. In this manner, the voltage of the inverting input terminal of the amplifier 111 slowly rises and the output of the amplifier 111 slowly falls. Then, the PMOS transistor 116 is controlled to be slowly turned on, by which the rush current which flows into the output terminal 104 is suppressed.

The slow turning on of the PMOS transistor 116 causes the output voltage VOUT of the output terminal 104 to start up gradually. The resistors 117 and 118 divide the output voltage VOUT and feed back the divided voltage to the non-inverting input terminal of the amplifier 111. The amplifier 111 controls the PMOS transistor 116 according to a difference in potential between the feedback voltage and the reference voltage VREF and continues the control until the output voltage VOUT reaches a desired voltage.

After the output voltage VOUT starts up, the voltage detection circuit 122 detects the output voltage VOUT and outputs a signal which turns off the NMOS transistor 121. In this manner, it is possible to prevent the current from flowing from the Nch depression transistor 112, thereby achieving low power consumption.

Although the NMOS transistor 121 is used as a switch circuit which interrupts the current of the Nch depression transistor 112, the switch circuit may have any other configuration such as, for example, the configuration of a PMOS transistor as long as the circuit is able to interrupt the current.

As described hereinabove, the voltage regulator of the first embodiment is able to gradually start up the output voltage VOUT to suppress the rush current and to prevent the current from flowing from the Nch depression transistor 112 after the output voltage VOUT starts up, thereby achieving low power consumption.

### Second Embodiment

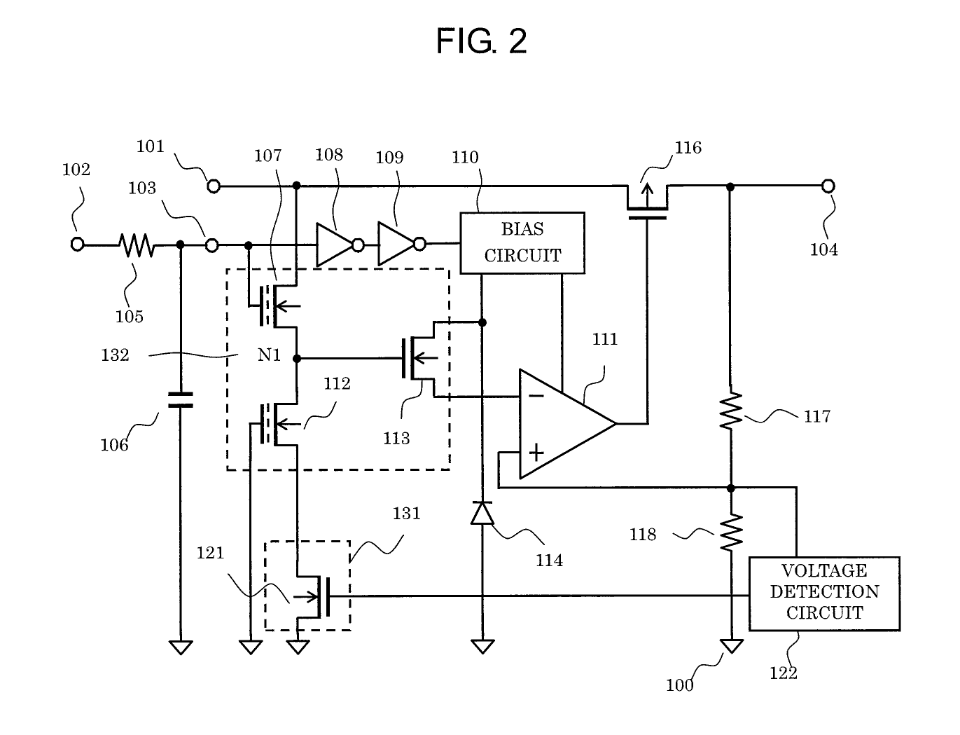

FIG. 2 is a circuit diagram illustrating a voltage regulator of a second embodiment. The circuit differs from the circuit illustrated in FIG. 1 in that the voltage detection circuit 122 is connected to a connection point between the resistor 117 and the resistor 118. Also in this configuration, it is possible to detect a voltage obtained by dividing the output voltage VOUT by the resistors 117 and 118 and to output a signal which turns off the NMOS transistor 121. In addition, it is possible to prevent the current from flowing from the Nch depression transistor 112, thereby achieving low power consumption.

Although the voltage which is detected by the voltage detection circuit 122 as an output voltage VOUT is the voltage at the connection point between the resistor 117 and the resistor 118 in this embodiment, the resistor circuit may be modified appropriately so as to take out a desired voltage.

Moreover, although the NMOS transistor 121 is used as the switch circuit which interrupts the current of the Nch depression transistor 112 similarly to the first embodiment, the switch circuit may have any other configuration such as, for example, the configuration of a PMOS transistor as long as the circuit is able to interrupt the current.

As described hereinabove, the voltage regulator of the second embodiment is able to gradually start up the output voltage VOUT to suppress the rush current and to prevent the current from flowing from the Nch depression transistor 112 after the output voltage VOUT starts up, thereby achieving low power consumption.

What is claimed is:

1. In a voltage regulator having:
a reference voltage generation circuit which generates a reference voltage;
an amplifier which amplifies and outputs a difference between the reference voltage and a divided voltage obtained by dividing a voltage output from an output transistor and controls a gate of the output transistor;
an external terminal which receives a signal which externally turns on/off a circuit; and
a rush current prevention circuit which transmits the reference voltage to the amplifier,
the improvement comprising:
a voltage detection circuit which detects a voltage based on the voltage output from the output transistor; and
a switch circuit which is connected to the rush current prevention circuit and interrupts a current which flows through the rush current prevention circuit in response to a signal from the voltage detection circuit.

2. The voltage regulator according to claim 1, wherein the voltage detection circuit detects a divided voltage obtained by dividing the voltage output from the output transistor.

3. The voltage regulator according to claim 1, wherein the switch circuit includes a PMOS transistor or an NMOS transistor.

4. The voltage regulator according to claim 2, wherein the switch circuit includes a PMOS transistor or an NMOS transistor.
